(19) United States
(12) Patent Application Publication
(10) Pub. No.: US 2016/0277262 A1
(43) Pub. Date: Sep. 22, 2016

(54) METHOD AND APPARATUS FOR TRACING SESSION AT POLICY SERVER

(71) Applicant: CISCO TECHNOLOGY, INC., San Jose, CA (US)

(72) Inventors: Vivek Santuka, Morrisville, NC (US); Aaron Troy Woland, Waxhaw, NC (US); Jesse Ryan Dubois, Durham, NC (US); Ramesh Nampelly, Sunnyvale, CA (US)

(73) Assignee: CISCO TECHNOLOGY, INC., San Jose, CA (US)

(21) Appl. No.: 14/664,752

(22) Filed: Mar. 20, 2015

(51) Int. Cl. H04L 12/26

(52) U.S. Cl. CPC H04L 43/08

(57) ABSTRACT

In one embodiment, a method includes receiving at a policy server, a request to trace a session at the policy server, tracing the session at the policy server, wherein tracing comprises running the session and identifying access results from the trace, and transmitting the access results from the policy server to a network device requesting the trace. An apparatus and logic are also disclosed herein.

### TECHNICAL FIELD

The present disclosure relates generally to communication networks, and more particularly, to policy servers.

### BACKGROUND

Policy servers may be used, for example, to create and enforce network access policies for clients, connection request authentication, and connection request authorization. A policy management server may use multiple factors such as identity, location, profile, and posture to determine the access policies applied to any individual session. Manual inspection of session attributes and rules applied may be needed to determine why a particular access rule and result has been applied to a session in conventional systems.

### BRIEF DESCRIPTION OF THE DRAWINGS

FIG. 1 illustrates an example of a network in which embodiments described herein may be implemented.

FIG. 2 depicts an example of a network device useful in implementing embodiments described herein.

FIG. 3 illustrates an example of a process for tracing a session at a policy server in the network of FIG. 1, in accordance with one embodiment.

FIG. 4 illustrates an example of a graphical user interface for use in entering search information for a session, in accordance with one embodiment.

FIG. 5 illustrates an example of a graphical user interface for use in creating a session, in accordance with one embodiment.

FIG. 6 illustrates an example of a graphical user interface for use in viewing policy trace results, in accordance with one embodiment.

FIG. 7 illustrates an example of processing for a sample session at the policy server, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises receiving at a policy server, a request to trace a session at the policy server, tracing the session at the policy server, wherein tracing comprises running the session and identifying access results from the trace, and transmitting the access results from the policy server to a network device requesting the trace.

In another embodiment, an apparatus generally comprises a processor for processing a request to trace a session at a policy server, tracing the session at the policy server, and transmitting access results from the policy server to a network device requesting the trace. The apparatus further comprises a policy engine for running the session through policies and memory for storing the policies and access results identified from the trace.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

The embodiments described herein may be used to identify a policy applied to a session at a policy server and test, modify, and verify changes to access policies applied to the session. As described in detail below, one or more embodiments reduce time and effort needed to write, test, and modify access policies on a policy server by providing a policy tracer and editor. The policy tracer allows a previous session from a history or a created session to be used to simulate the policy flow and result of the flow. The policy editor allows the conditions and result of the trace to be modified to view the effect of the changes. The embodiments may be used to match access results for a session back to the configuration and attributes and thereby provide a quick way to identify access results and reasons for the results, for any authentication or authorization request. The embodiments eliminate the need to manually go through large amounts of data to determine why a particular access rule and result has been applied to a session.

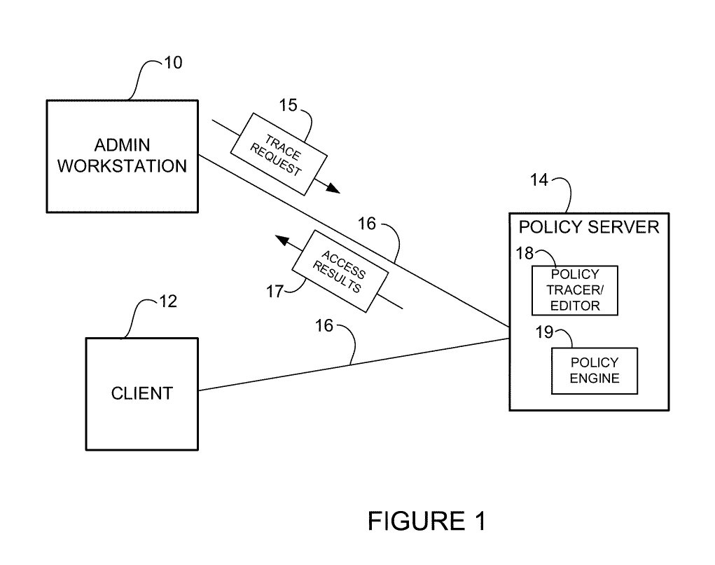

Referring now to the drawings, and first to FIG. 1, a network in which embodiments described herein may be implemented is shown. For simplification, only a small number of nodes are shown. The embodiments operate in the context of a data communication network including multiple network devices. The network may include any number of network devices in communication via any number of nodes (e.g., routers, switches (e.g., data center switches), gateways (e.g., VPN (virtual private network) gateways), controllers (e.g., wireless local area network controllers), or other network devices), which facilitate passage of data within the network. The nodes may communicate over one or more networks (e.g., local area network (LAN), metropolitan area network (MAN), wide area network (WAN), virtual private network (VPN), virtual local area network (VLAN), wireless network, enterprise network, Internet, intranet, radio access network, public switched network, or any other network).

The network shown in the example of FIG. 1 includes network devices 10, 12 in communication with a policy server 14. The network devices 10, 12 may be any computer, processor, network appliance, or other suitable device, component, element, or object capable of sending, receiving, or forwarding information over a communication network. The network devices 10, 12 may be in communication with the policy server 14 over any number of links 16 comprising any number of intermediate nodes, and over one or more networks.

In one example, network device (admin workstation, management device) 10 is a node operated by a network administrator, network integrator, or other network user. The node 10 may be used, for example, to simulate sessions between client 12 and the policy server 14. The network device 10 may also be used to modify sessions at the policy server 14 and view the impact of changes to the session. As shown in FIG. 1, the node 10 may transmit a trace request 15 to the policy server 14 and receive access results 17 after the trace is performed at the policy server.

The client (endpoint, station) 12 may be, for example, a desktop computer, laptop computer, IP (Internet Protocol) phone, server, appliance, game console, printer, camera, sensor, mobile phone, tablet, personal digital assistant, or any other device configured for communication with the policy server 14. The client 12 may be a managed or unmanaged device. For example, a user may attempt to access a network from a corporate-managed personal computer, personal network-accessible device, or public terminal. The client 12 may be a wired device or wireless device, or configured for both wired communication (e.g., connected to a docking station) and wireless communication.

The policy server 14 may be any network device operable to provide network access to one or more networks. For example, the policy server 14 may be an identity and access control policy platform that enables enterprises to enforce compliance and enhance infrastructure security (e.g., Identity Services Engine (ISE)). The policy server 14 may include, for example, one or more access directory, access control server, AAA (authentication, authorization and accounting) server/proxy, application server, controller, security manager, client profile manager, or any other node, combination of nodes, or source (e.g., network administrator) that provides authentication or policy information for the clients 12. The authentication server may use, for example IEEE 802. lx (Port Based Network Access Control), EAP (Extensible Authentication Protocol), EAPoUDP (EAP over User Datagram Protocol), Web Portal authentication, RADIUS (Remote Authentication Dial in User Service), Diameter, or any other authentication scheme. The policy server 14 may also provide support for discovery, profiling, and accessing device posture for endpoint devices, for example. The policy server 14 may be a computer, processor, network appliance, or other suitable device, component, element, or object capable of performing operations described herein. The policy tracer/editor 18, policy engine 19, and session database may all be located at the same node or one or more the components may be located at a separate node. For example, the session database may be stored on a separate monitoring node and the policy tracer 18 may search or fetch results from the database. Thus, the term “policy server” as used herein may refer to one or more network devices or a distributed platform.

The policy server 14 includes a policy engine 19 for running a policy session at the policy server. As described in detail below, the policy server 14 further comprises a policy tracer/editor 18 operable to simulate a policy flow at the policy server, provide results of the flow, and allow the result to be modified and the effect of the changes to the policy flow to be viewed.

In one embodiment, a sample session (access session) may be injected, either from a history or by entering key characteristics of the session. The policy server 14 applies authentication and authorization policies and the policy tracer 18 outputs the resultant policy and permissions and the reasons why those policies and permissions were used (access results). The policy server 14 may also use profiling and posture information learned from the sample session along with the authentication and authorization policies to determine the output.

As described further below, the policy editor 18 allows for modification to characteristics of the sample session to allow visualization of changes in the output. The policy editor may also allow the user to define the intended output to identify changes needed to policies to achieve a given result.

It is to be understood that the network shown in FIG. 1 and described above is only an example and the embodiments described herein may be implemented in networks comprising different network topologies or network devices, or using different protocols, without departing from the scope of the embodiments. For example, the network may include any number or type of network devices that facilitate passage of data over the network (e.g., routers, switches, gateways, controllers), network elements that operate as endpoints or hosts (e.g., servers, virtual machines, clients), and any number of network sites in communication with any number of networks. Thus, network nodes may be used in any suitable network topology, which may include any number of servers, accelerators, virtual machines, switches, routers, or other nodes interconnected to form a large and complex network. Nodes may be coupled to other nodes through one or more interfaces employing any suitable wired or wireless connection, which provides a viable pathway for electronic communications.

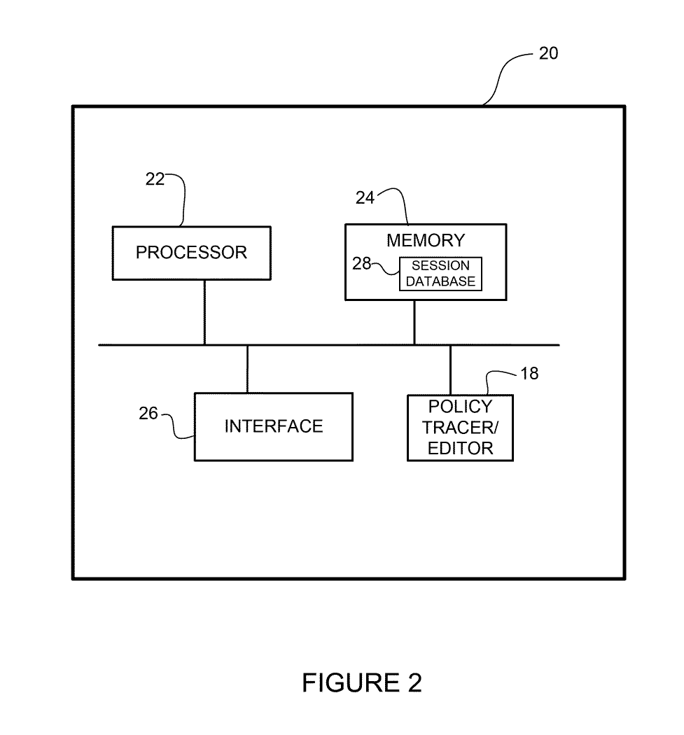

FIG. 2 illustrates an example of a network device 20 (e.g., policy server 14 in FIG. 1) that may be used to implement the embodiments described herein. In one embodiment, the network device 20 is a programmable machine that may be implemented in hardware, software, or any combination thereof. The network device 20 includes one or more processor 22, memory 24, network interface 26, and the policy tracer/editor 18 (e.g., hardware, software components).

Memory 24 may be a volatile memory or non-volatile storage, which stores various applications, operating systems, modules, and data for execution and use by the processor 22. Memory 24 may include, for example, one or more session database 28, access database or list, policy table, or any other data structure configured for storing policy, session history, access information, or user information. One or more components of the policy tracer/editor 18 (e.g., code, logic, software, firmware, etc.) may also be stored in memory 24. The network device 20 may include any number of memory components.

Logic may be encoded in one or more tangible media for execution by the processor 22. For example, the processor 22 may execute codes stored in a computer-readable medium such as memory 24. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium. In one example, the computer-readable medium comprises a non-transitory computer-readable medium. The network device 20 may include any number of processors 22.

The network interface 26 may comprise any number of interfaces (linecards, ports) for receiving data or transmitting data to other devices. The network interface 26 may include, for example, an Ethernet interface for connection to a computer or network. The network interface 26 may be configured to transmit or receive data using a variety of different communication protocols. The interface 26 may include mechanical, electrical, and signaling circuitry for communicating data over physical links coupled to the network.

It is to be understood that the network device 20 shown in FIG. 2 and described above is only an example and that different configurations of network devices may be used. For example, the network device 20 may further include any suitable combination of hardware, software, algorithms, processors, devices, components, modules, or elements operable to facilitate the capabilities described herein.

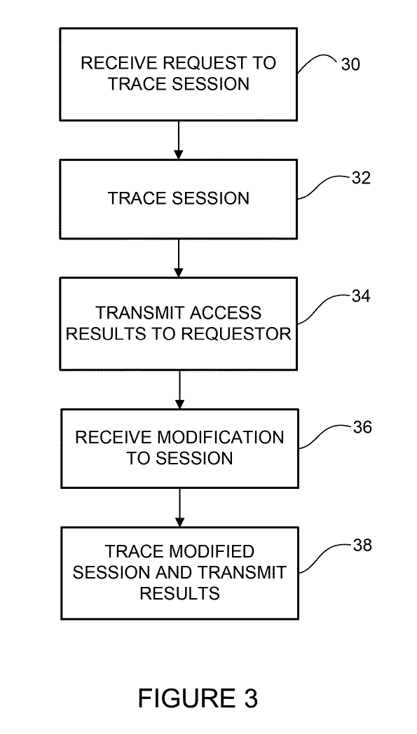

FIG. 3 is a flowchart illustrating an overview of a process for identifying, modifying, and testing access policies applied to a session at the policy server 14. At step 30, the policy server 14 receives a request to trace a session. The trace request 15 may be received from the admin workstation (requestor) 10 in FIG. 1. As described below, a graphical user interface (GUI) may be used at node 10 to identify a session to trace at the policy server 14. The session may be selected from a history of sessions or a new session may be created. Upon receiving the request, the policy server 14 traces the session (step 32). This may comprise running the session at the policy server 14 and identifying access results from the trace. For example, results of authentication, authorization, profiling, posturing, or any other process performed or data collected during the session may be identified during the trace. The policy server 14 transmits the access results 17 to the requestor 10 of the trace (step 34) (FIGS. 1 and 3). In one embodiment, a modification of the session (e.g., changes to session, conditions (policies, rules), results) is entered at the admin workstation 10 and transmitted to the policy server 14 (step 36). The policy server 14 runs the modified session and transmits the results to the network device 10 (step 38).

It is to be understood that the process shown in FIG. 3 and described above, is only an example and that steps may be added, deleted, combined, or modified without departing from the scope of the embodiments.

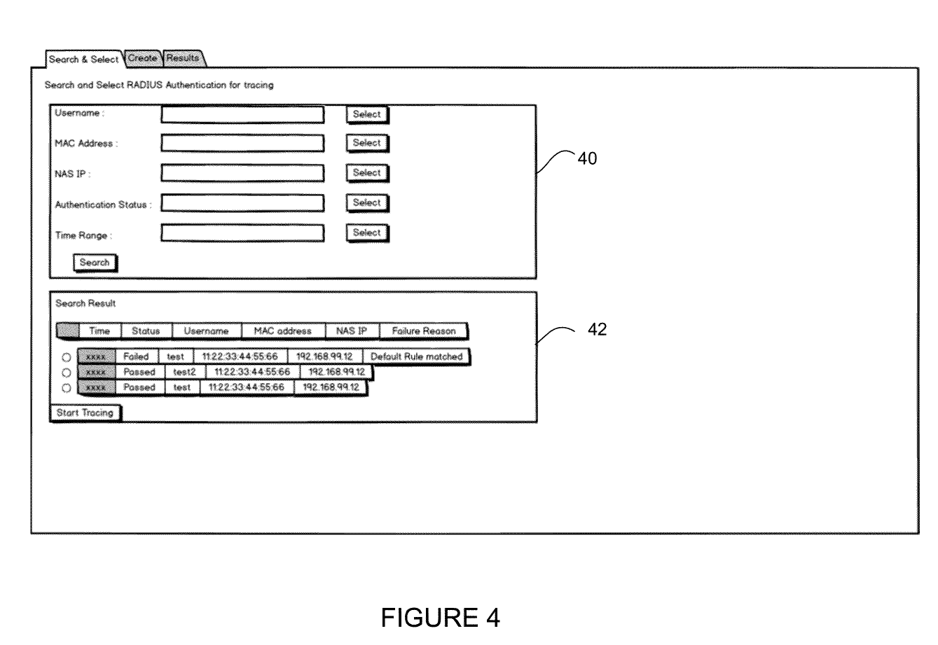

In one embodiment, the policy tracer/editor 18 is implemented using a graphical user interface (GUI). FIGS. 4, 5, and 6 illustrate examples of screen views of a GUI, in accordance with one embodiment.

In one example, a past session stored in a database (e.g., session database 28 in FIG. 2) is used to automatically build the session to be traced at the policy server 14. The session may be pulled from the database 28 and built in the GUI, for example, so that an administrator can make changes and retest the session. FIG. 4 illustrates an example of a GUI that may be used to search and select a session. The GUI includes a section 40 for entering search information. In one example, the user may enter a username, MAC (Media Access Control) address, NAS (Network Access Server) IP (Internet Protocol) address, authentication status, and time range. Upon entering this information and selecting a search icon, search results appear as shown at 42. The user may then select one of the search results for tracing.

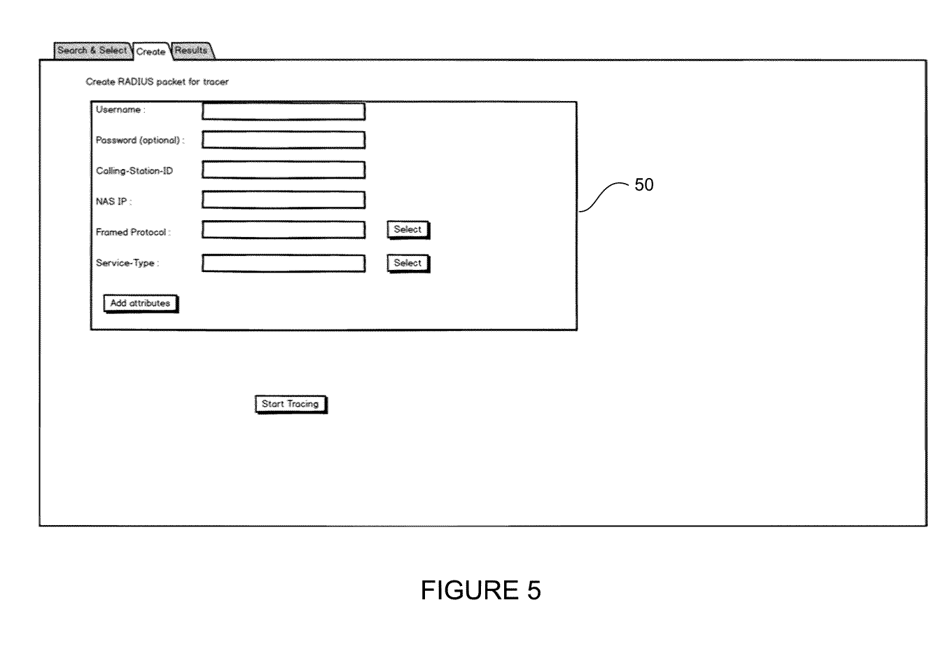

In another example, the GUI may be used to build a session that is then run through the policy trace tool. Any attribute or value available to the policy engine may be available to the administrator when building the session. While building the session, the administrator may have an option to query the system for current values for a particular client (user, endpoint), group, profile, stored attribute/value, etc. FIG. 5 illustrates an example of a GUI that may be used to create a session. In the example shown in FIG. 5, the following information is entered (or selected) at block 50: username; password; calling station identifier (ID); NAS (Network Access Server) IP (Internet Protocol) address; framed protocol; and service type. Upon receiving this input, the policy server 14, processes it through its policy engine as it would a normal session received from the client 12.

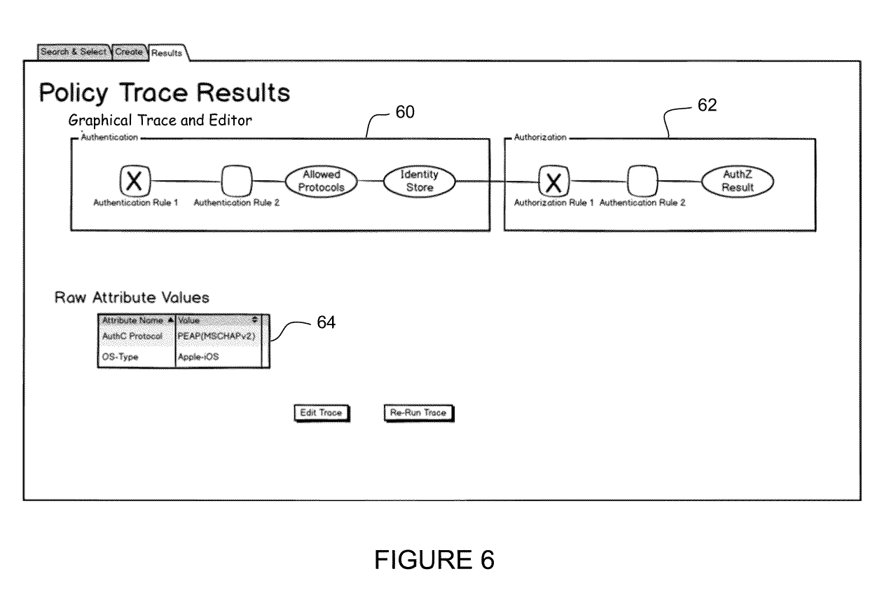

As shown in FIG. 6, after processing the session, the policy tracer may output progression of the session through authentication and authorization stages (60, 62), including details of each rule the session progressed through. The policy tracer may also output attributes (as shown at 64) that caused a rule to be matched, the delta between the rules, the session attributes for each rule that did not match the session, and a complete list of session attributes that were gathered from various sources such as profiling, external databases, and the like, for that session, whether or not it was used to match a rule. The user may then edit the trace or rerun the trace by selecting appropriate icons on the GUI.

It is to be understood that the GUIs shown in FIGS. 4, 5, and 6 are only examples and that other formats containing less, more, or different information or other fields or selectable icons may be used, without departing from the scope of the embodiments.

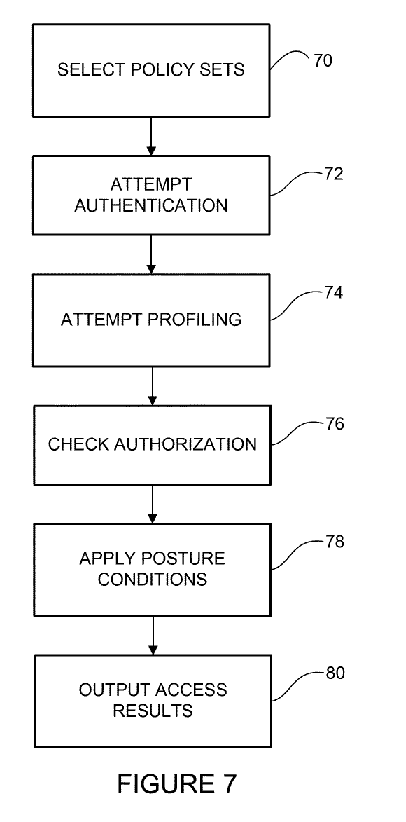

FIG. 7 is a flowchart illustrating an example of processing that the policy server 14 may run a sample session through, in accordance with one embodiment. At step 70, the policy server 14 selects policy sets or a first set of rules to determine which authentication rule set to apply. The policy server 14 then evaluates authentication rules and attempts an authentication based on the information provided (step 72). The policy server 14 may then attempt to profile the device based on information in the same session and any information already stored for the endpoint (step 74). At step 76, the policy server 14 checks its authorization rules to see which one matches the session based on information provided and gathered in steps 72 and 74. If there are any posture conditions, they may be applied based on the results of step 76 (step 78). The policy server 14 can then output the access results and transmit to the admin workstation 10 (step 80).

Once the complete output from the tracer is available, the editor mode may be enabled to allow the user to modify the sample session, conditions on one or more steps, or the end result. Once all changes are completed, the user may request a rerun of the trace on the modified session. The tracer may then repeat the steps shown in FIG. 7. This cycle may be repeated any number of times.

It is to be understood that the process shown in FIG. 7 is only an example and that steps may be added, removed, combined, reordered, or modified, without departing from the scope of the embodiments. For example, authorization may take place before or after profiling or posture, or may occur multiple times (e.g., after authentication, profiling, and posture).

If after initial configuration of the policy server 14, a test session fails, the administrator may select the failed attempt from the session history and run the tracer on the failed attempt. The tracer may use attributes from the session and run it through policies at the policy server 14. The following is an example of output from the policy tracer:
1. Ruleset selected: Default
2. Authentication rule matched: Default based on authentication protocol of PEAP MsChapv2
3. Authentication store matched: Active Directory based on authentication protocol PEAP MsChapv2
4. Active Directory authentication: Successful
5. Active Directory Groups retrieved: <list of groups>
6. Authorization Rule #1 not matched: User not part of Active Directory Group <name>
7. Authorization Rule #2 matched (Default): Access Rejected

The output from the policy tracer in the above example shows that the user is not part of the Active Directory group that is allowed access by Rule #1. The policy editor may then be enabled to allow the administrator to change authorization Rule #1 to match another group that is listed in step 5. Upon running the policy tracer again, the authorization rule in step 6 will be matched and the user will be allowed access. This tells the administrator the change needed in the actual rules that will cause an expected access result. It is then possible to apply the changes to the rules directly from the policy editor.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
receiving at a policy server, a request to trace a session at the policy server;
tracing said session at the policy server, wherein tracing comprises running said session and identifying access results from said trace; and
transmitting said access results from the policy server to a network device requesting said trace.

2. The method of claim 1 further comprising:
receiving at the policy server, a modification to said session;
tracing said modified session at the policy server; and
transmitting access results of said modified session to the network device.

3. The method of claim 2 wherein said modification comprises changes to a rule at the policy server.

4. The method of claim 1 further comprising searching for said session in a session database using input received from the network device.

5. The method of claim 1 further comprising creating said session based on input received from the network device.

6. The method of claim 1 wherein identifying said access results comprises identifying authentication and authorization results.

7. The method of claim 1 wherein said access results comprise rules applied to said session and attributes used to match one or more of said rules.

8. The method of claim 1 wherein said session comprises a simulated session between an endpoint and the policy server.

9. An apparatus comprising:
a processor for processing a request to trace a session at a policy server, tracing said session at the policy server, and transmitting access results from the policy server to a network device requesting said trace;
a policy engine for running said session through policies; and
memory for storing said policies and said access results identified from said trace.

10. The apparatus of claim 9 wherein the processor is further configured to process a request to modify said session, trace said modified session, and transmit access results of said modified session to the network device.

11. The apparatus of claim 10 wherein said modification comprises changes to said access results.

12. The apparatus of claim 9 wherein the memory further comprises a session database for storing sessions and wherein the processor is further configured for searching for said session in the session database using input received from the network device.

13. The apparatus of claim 9 wherein said session is created based on input received from the network device.

14. The apparatus of claim 9 wherein said access results comprise authentication and authorization results.

15. The apparatus of claim 9 wherein said access results comprise rules applied to said session and attributes used to match one or more of said rules.

16. The apparatus of claim 9 wherein said session comprises a simulated session between an endpoint and the policy server.

17. Logic encoded on one or more non-transitory computer readable media for execution and when executed operable to:
process a request to trace a session at a policy server;
trace said session at the policy server, wherein tracing comprises running said session and identifying access results from said trace; and
transmit said access results from the policy server to a network device requesting said trace.

18. The logic of claim 17 further operable to:
process a modification to said session;
trace said modified session; and
transmit access results of said modified session to the network device;
said modification input at a graphical user interface.

19. The logic of claim 17 wherein said access results comprise authentication and authorization results.

20. The logic of claim 17 wherein said access results comprise rules applied to said session and attributes used to match one or more of said rules.
